(19) United States
(12) Patent Application Publication
(10) Pub. No.: US 2025/0330959 A1
(43) Pub. Date: Oct. 23, 2025

(54) METHODS, COMMUNICATIONS DEVICES, AND NETWORK INFRASTRUCTURE EQUIPMENT

(71) Applicant: Sony Group Corporation, Tokyo (JP)

(72) Inventors: Shin Horng WONG, Basingstoke (GB); Martin Warwick BEALE, Basingstoke (GB)

(73) Assignee: Sony Group Corporation, Tokyo (JP)

(21) Appl. No.: 18/880,852

(22) PCT Filed: Jul. 6, 2023
(86) PCT No.: PCT/EP2023/068771

§ 371 Date: Jan. 3, 2025

(30) Foreign Application Priority Data
Jul. 13, 2022 (EP) 22184813.8

(51) Int. Cl. H04W 72/0446; H04L 5/00

(52) U.S. Cl. CPC H04W 72/0446; H04L 5/0048

(57) ABSTRACT

A method, an infrastructure equipment, and circuitry for an infrastructure equipment to inform another infrastructure equipment of a format of one or more OFDM symbols of the infrastructure equipment. The infrastructure equipment identifies a format of the one or more OFDM symbols and provides a slot and subband format indicator to one or more other infrastructure equipments via a wireless radio interface to inform the other infrastructure equipment of the format of the one or more OFDM symbols for the infrastructure equipment.

The present application claims the Paris Convention priority of European patent application EP22184813.8, filed 13 Jul. 2022, the contents of which are hereby incorporated by reference.

### BACKGROUND

### Field of Disclosure

The present disclosure relates to a communications device, network infrastructure equipment and methods of operating a communications device to receive data from a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Modern mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Wireless communications networks are expected to routinely and efficiently support communications with an ever-increasing range of devices associated with a wide range of data traffic profiles and types. For example, it is expected that wireless communications networks efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is a desire for current generation wireless communications networks, for example those referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

According to a first example, there is provided a method for an infrastructure equipment, the method comprising: identifying a format of at least a portion of one or more timing slots of the infrastructure equipment, wherein the format of the at least a portion of the one or more timing slots includes an allocation of resources by the infrastructure equipment to a particular type of traffic, the particular type of traffic being at least either downlink traffic or uplink traffic; transmitting, to one or more other infrastructure equipments via a wireless radio interface provided by the wireless communications network, one or more slot and subband format indicators, SSFIs, within a first slot of the one or more timing slots, wherein the one or more slot format indicators indicate the format of the at least a portion of the one or more timing slots.

According to a second example, there is provided a method for an infrastructure equipment, the method comprising: monitoring, in one or more timing slots, a wireless radio interface for a transmission from another infrastructure equipment for one or more slot and subband format indicators, SSFIs; determining, based on the monitoring for one or more SSFIs, a format of the at least a portion of the one or more timing slots for the other infrastructure equipment, wherein the format of the at least a portion of the one or more timing slots includes an allocation of resources by the other infrastructure equipment to a particular type of traffic, the particular type of traffic being at least either downlink traffic or uplink traffic.

According to a third example, there is provided a method for a communications device, the method comprising: receiving, from an infrastructure equipment, an indication of a timing and/or frequency of one or more slot and subband format indicators, SSFIs, wherein the one or more SSFIs indicate a format of the at least a portion of one or more timing slots for the infrastructure equipment, wherein the format of the at least a portion of the one or more timing slots includes an allocation of resources by the infrastructure equipment to a particular type of traffic, the particular type of traffic being at least either downlink traffic or uplink traffic.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of inter-cell cross link interference.

FIG. 5 illustrates an example approach for accounting for inter-cell cross link interference.

FIG. 6 illustrates an example of atmospheric ducting and remote interference.

FIG. 7 illustrates the slot alignments in the example of remote interference according to FIG. 6.

FIG. 8 illustrates a process for mitigating the effects of remote interference.

FIG. 9 schematically illustrates an example of intra-cell cross link interference

FIG. 10 illustrates an example division of system bandwidth into dedicated uplink and downlink sub-bands.

FIG. 11 illustrates an example of transmission power leakage.

FIG. 12 illustrates an example of receiver power selectivity.

FIG. 13 illustrates an example of inter sub-band interference.

FIG. 14 illustrates an example of intra sub-band interference.

FIG. 15 illustrates the use of a slot and subband format indicator reference signal (SSFI-RS) by an infrastructure equipment to indicate the format of at least a portion of a slot to another infrastructure equipment, according to an example of the present disclosure.

FIG. 16 illustrates the use of a SSFI-RS by an infrastructure equipment to indicate the format of at least a portion of a slot to another infrastructure equipment, according to an example of the present disclosure.

FIG. 17 illustrates the use of a SSFI-RS by an infrastructure equipment to indicate the format of at least a portion of a slot to another infrastructure equipment, according to an example of the present disclosure.

FIG. 18 illustrates the use of a SSFI-RS by an infrastructure equipment to indicate the format of at least a portion of a slot to another infrastructure equipment, according to an example of the present disclosure.

FIG. 19 illustrates a flow diagram of a method for an infrastructure equipment according to an example of the present disclosure.

FIG. 20 illustrates a flow diagram of a method for an infrastructure equipment according to an example of the present disclosure.

FIG. 21 illustrates a flow diagram of a method for a communications device according to an example of the present disclosure.

### DETAILED DESCRIPTION OF THE EMBODIMENTS

### Long Term Evolution Advanced Radio Access Technology (4G)

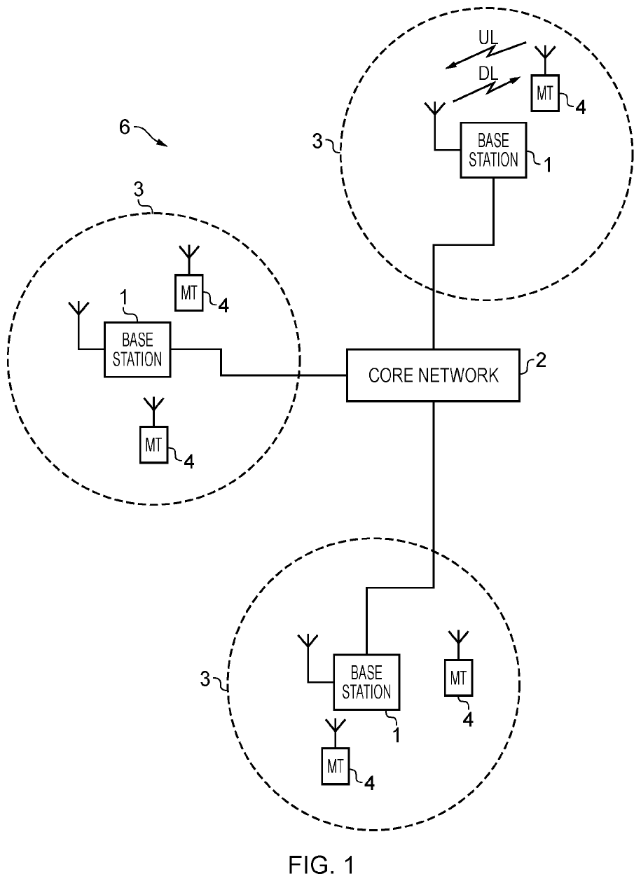

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G (NR))

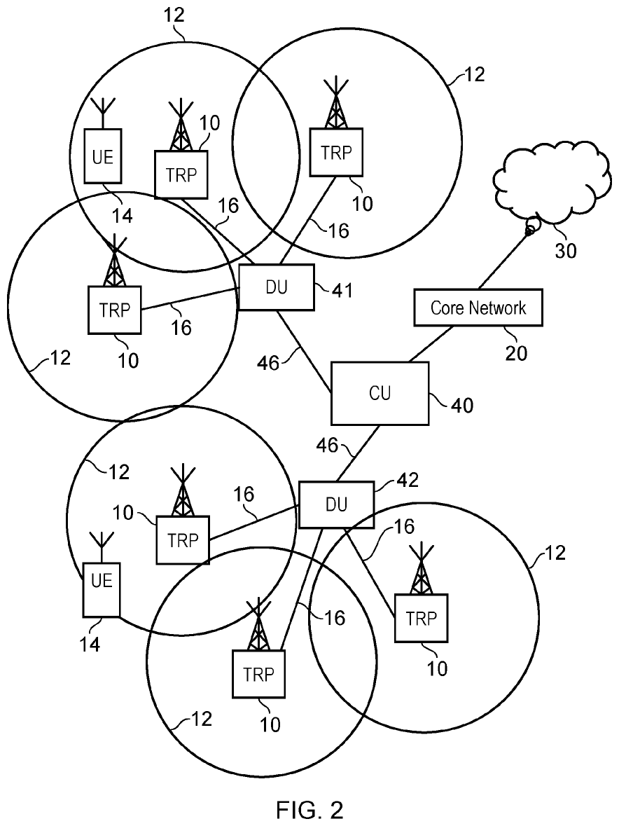

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

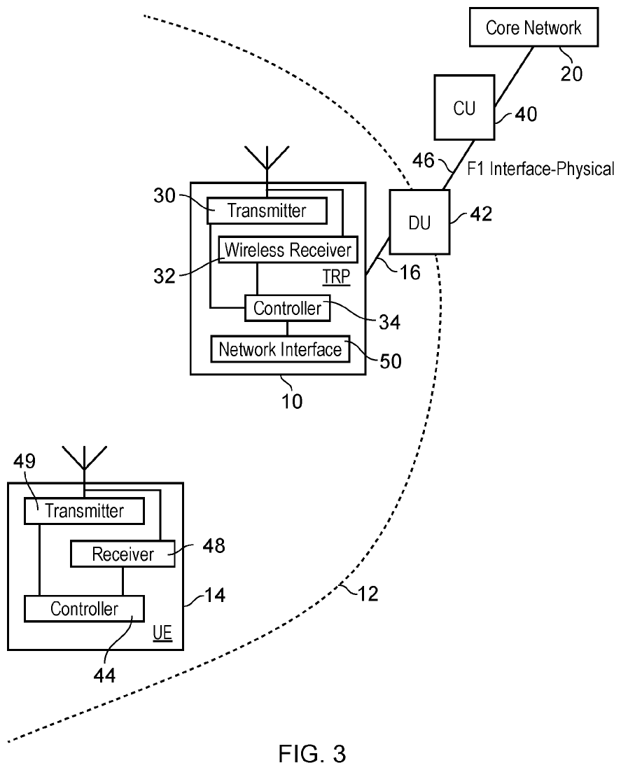

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band or carrier is switched to either downlink or uplink transmissions for a time period and can be switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for Time Division Multiplexing (TDD) by enabling Full Duplex operation in TDD (FD-TDD) [2]. In FD-TDD, a gNB can transmit and receive data to and from the UEs at the same time on the same frequency band or carrier. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling an UL transmission from a second UE within the same orthogonal frequency division multiplexing (OFDM) symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD. Development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, OFDM symbols are allocated only for either a DL or UL direction in a semi-static manner. Hence, if one direction experiences less or no data, the spare resources cannot be used in the other direction, or are, at best, under-utilized. However, if resources can be used for DL data and UL data (as in FD-TDD) at the same time, the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

### Inter-Cell Cross Link Interference (CLI)

In NR systems, a slot format (i.e. the allocation of DL and UL OFDM symbols in a slot) can be semi-statically or dynamically configured, where each OFDM symbol (OS) in a slot can be configured as Downlink (DL), Uplink (UL) or Flexible (F). An OFDM symbol that is semi-statically configured to be Flexible can be indicated dynamically as DL, UL or remain as Flexible by a Dynamic Slot Format Indicator (SFI), which is transmitted in a Group Common (GC) DCI using DCI Format 2_0, where the CRC of the GC-DCI is masked with SFI-RNTI.

Flexible OFDM Symbols that remain Flexible after instruction from the SFI can be changed to a DL symbol or an UL symbol by a DL Grant or an UL Grant respectively. That is, a DL Grant scheduling a PDSCH that overlaps Flexible OFDM Symbols would convert these Flexible OFDM Symbols to DL and similarly an UL Grant scheduling a PUSCH that overlaps Flexible OFDM Symbols would convert these Flexible OFDM Symbols to UL.

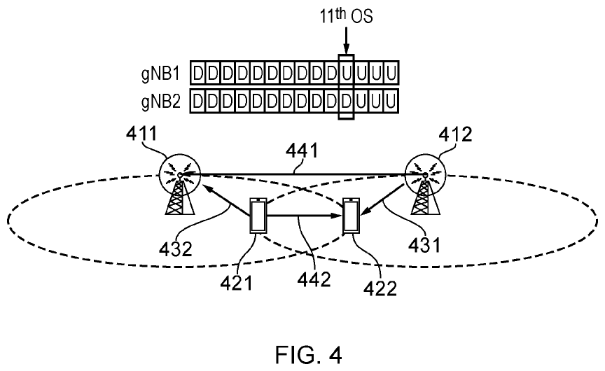

Since each gNB in a network can independently change the configuration of each OFDM symbol, either semi-statically or dynamically, it is possible that in a particular OFDM symbol, one gNB is configured for UL and a neighbour gNB is configured for DL. This causes inter-cell Cross Link Interference (CLI) among the conflicting gNBs. Inter-cell CLI occurs when a UE's UL transmission interferes with a DL reception by another UE in another cell, or when a gNB's DL transmission interferes with an UL reception by another gNB. That is, inter-cell CLI is caused by non-aligned (conflicting) slot formats among neighbouring cells. An example is shown in FIG. 4, where gNB1 411 and gNB2 412 have synchronised slots. At a given slot, gNB1's 411 slot format={D, D, D, D, D, D, D, D, D, D, U, U, U, U} whilst gNB2's 412 slot format={D, D, D, D, D, D, D, D, D, D, D, U, U, U}, where ‘D’ indicates DL and ‘U’ indicates UL. Inter-cell CLI occurs during the 11th OFDM symbol of the slot, where gNB1 411 is performing UL whilst gNB2 412 is performing DL. Specifically, inter-cell CLI 441 occurs between gNB1 411 & gNB2 412, where gNB2's 412 DL transmission 431 interferes with gNB1's 411 UL reception 432. CLI 442 also occurs between UE1 421 & UE2 422, where UE1's 421 UL transmission 432 interferes with UE2's 422 DL reception 431.

Some legacy implementations attempt to reduce inter-cell CLI in TDD networks caused by flexible and dynamic slot format configurations. Two CLI measurement reports to manage and coordinate the scheduling among neighbouring gNBs include: sounding reference signal (SRS) reference signal received power (RSRP) and CLI received signal strength indicator (RSSI). In SRS-RSRP, a linear average of the power contribution of an SRS transmitted by a UE is measured by a UE in a neighbour cell. This is measured over the configured resource elements within the considered measurement frequency bandwidth, in the time resources in the configured measurement occasions. In CLI-RSSI, a linear average of the total received power observed is measured only at certain OFDM symbols of the measurement time resource(s), in the measurement bandwidth, over the configured resource elements for measurement by a UE.

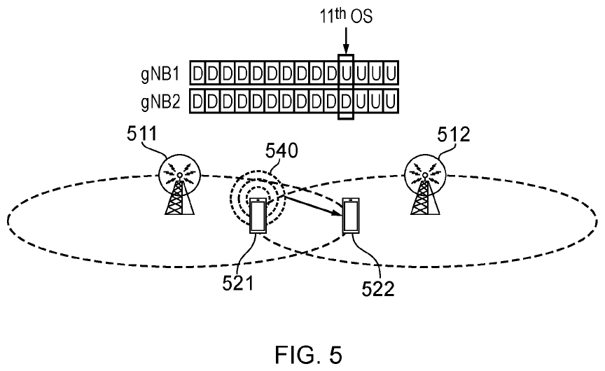

Both SRS-RSRP and CLI-RSSI are RRC measurements and are performed by a UE, for use in mitigating against UE to UE inter-cell CLI. For SRS-RSRP, an aggressor UE (i.e. a UE whose UL transmissions cause interference at another UE in a neighbouring cell) would transmit an SRS in the uplink and a victim UE (i.e. a UE that experiences interference due to an UL transmission from the UE in the neighbouring cell) in a neighbour cell would be configured with a measurement configuration including the aggressor UE's SRS parameters, in order to allow the interference from the aggressor UE to be measured. An example is shown in FIG. 5 where, at a particular slot, the 11th OS (OFDM symbol) of gNB1 511 and gNB2 512 causes inter-cell CLI. Here, gNB1 511 has configured UE1 521, the aggressor UE, to transmit an SRS 540 and gNB2 512 has configured UE2 522, the victim UE, to measure that SRS 540. UE2 522 is provided with UE1's 521 SRS configured parameters, e.g. RS sequence used, frequency resource, frequency transmission comb structure & time resources, so that UE2 522 can measure the SRS 540. In general, a UE can be configured to monitor 32 different SRSs, at a maximum rate of 8 SRSs per slot.

For CLI-RSSI measurements, the UE measures the total received power, i.e. signal and interference, following a configured periodicity, start & end OFDM symbols of a slot, and a set of frequency Resource Blocks (RBs). Since SRS-RSRP measures a transmission by a specific UE, the network can target a specific aggressor UE to reduce its transmission power and in some cases not schedule the aggressor UE at the same time as a victim UE that reports a high SRS-RSRP measurement. In contrast, CLI-RSSI cannot be used to identify a specific aggressor UE's transmission, but CLI-RSSI does provide an overall estimate of the inter-cell CLI experienced by the victim UE.

### Remote Interference Management (RIM)

Inter-cell CLI may even occur in a network with aligned (i.e. identical) slot formats across gNBs. In particular, this may occur due to a phenomenon known as atmospheric ducting where, due to certain weather conditions, an effective waveguide may form in the atmosphere. As such, radio transmissions may be ducted (i.e. guided) from a remote aggressor gNB to a distant victim gNB potentially many kilometres away (outside the usual transmission range of the aggressor gNB). Due to propagation delay along such large distances, a DL transmission from an aggressor gNB may arrive at the victim gNB within an UL OFDM symbol or UL slot of the victim gNB, thereby causing CLI. This may be referred to as remote interference [3].

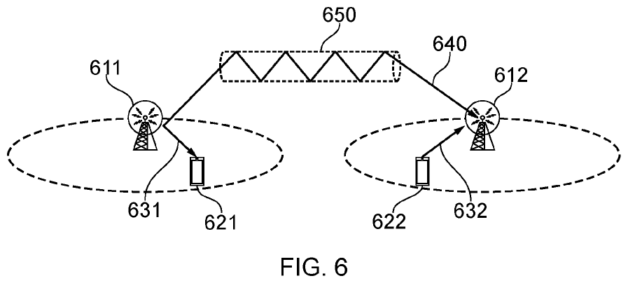

FIG. 6 shows an example of remote interference. Here gNB1 611 and gNB2 612 may be remote from one another (i.e. gNB2 612 is outside of the usual transmission range of gNB1 611). A DL transmission 631 from gNB1 611 to UE1 621 experiences atmospheric ducting 650 and is therefore guided through an effective waveguide across a large distance to gNB 612. At gNB2 612, the DL transmission 631 from gNB1 611 interferes 640 with UL reception 632 from UE2 622 at gNB2 612.

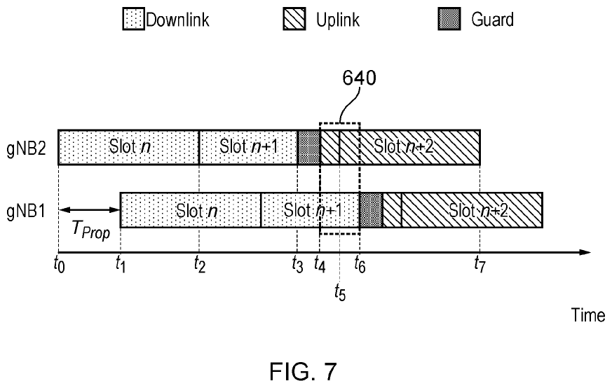

FIG. 7 illustrates remote interference in terms of the slot format and timings of gNB1 611 and gNB 612. Both gNB1 and gNB2 have the same slot format, where slot n (from time t₀ to t₂) is assigned to DL, slot n+1 (from time t₂ to t₅) is assigned to DL from time t₂ to t₃, a guard period from time t₃ to t₄ and UL from time t₄ to t₅, and slot n+2 (from time t₅ to t₇) is assigned to UL. The DL transmissions 631 from gNB1 611 arrive at gNB2 612 with propagation delay of T_{Prop}, thereby causing the DL portion of Slot n+1 of gNB1 611 to be received until time to and thus interfere 640 with the UL portion of gNB2 612 in Slot n+1 and Slot n+2, between time t₄ and t₆.

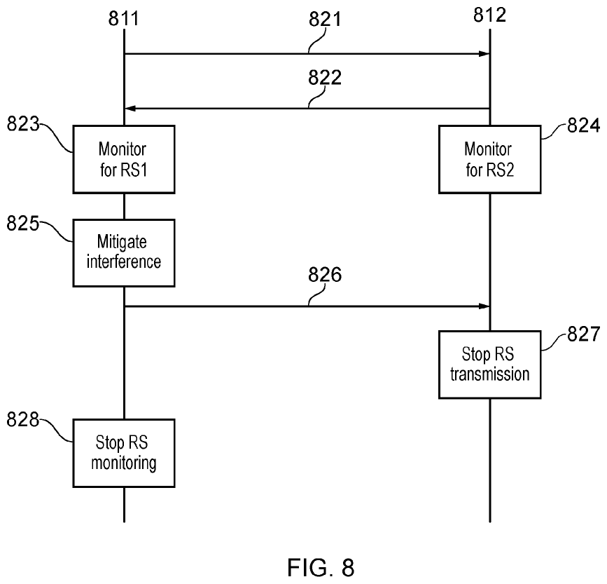

In an attempt to manage remote interference, Remote Interference Management (RIM) has been introduced. RIM introduces two Reference Signals (RS): RIM-RS1 and RIM-RS2, where RIM-RS1 is transmitted by a victim gNB and RIM-RS2 is transmitted by an aggressor gNB. The RIM process is described with reference to FIG. 8. The process is as follows:
Step 0: The victim gNB 812 experiences Remote Interference, e.g. an increase in Interference Over Thermal (IoT), as a result of transmissions 821 from the aggressor gNB 811.
Step 1: The victim gNB 812 begins transmitting RIM-RS1 822 and monitoring 824 for RIM-RS2 transmissions. The victim gNB 812 may also inform Operations, Administration and Maintenance (OAM) that it has commenced the RIM process, and the OAM would then instruct the aggressor gNB 811 to start monitoring 823 for RIM-RS1. The aggressor gNB 811 may alternatively begin monitoring 823 for RIM-RS1 822 when it also experiences remote interference.
Step 2: The aggressor gNB 811 applies remote interference mitigation schemes 825 to attempt to reduce the level of remote interference at the victim gNB 812. For example, the aggressor gNB 811 may reduce its DL transmission 821 power or may mute certain DL OFDM symbols that may cause remote interference at the victim gNB 812. The aggressor gNB 811 also begins transmitting RIM-RS2 826. The victim gNB 812 can then use RIM-RS2 826 to detect the level of remote interference from the aggressor gNB 811.
Step 3: Step 2 continues until the level of remote interference disappears or reduces to an acceptable level, at which point the victim gNB 812 will stop transmitting 827 RIM-RS1.
Step 4: When the aggressor gNB 811 is no longer able to detect RIM-RS1 822, the aggressor gNB 811 determines that the remote interference mitigation scheme 825 applied has been successful, or the atmospheric ducting has disappeared, and thus that the remote interference at the victim gNB 812 has disappeared or reduced to an acceptable level. The victim gNB 812 may also inform the OAM that the remote interference is no longer an issue and the OAM signals this information to the aggressor gNB 811 so that the aggressor gNB 811 is aware of the interference not being an issue at the victim gNB 812. The aggressor gNB 811 will then stop monitoring 828 for RIM-RS1 822 and stop transmitting RIM-RS2 826.

In this manner, remote interference at a victim gNB can be eliminated or reduced to an acceptable level. Here, RIM-RS1 can be used by the victim gNB as an indicator of whether the current mitigation steps taken by the aggressor gNB are adequate. For example, RIM-RS1 indicates whether the mitigation steps are adequate and no further action is needed, or whether the mitigation steps are not adequate and further mitigation steps are needed. Accordingly, the aggressor gNB is made aware of whether its mitigation steps can successfully reduce the remote interference. The use of RIM-RS1 as such an indicator can be enabled or disabled by the OAM.

Furthermore, the set of gNBs may be associated with a Set ID, where they are configured to use the same RIM-RS. An aggressor gNB detecting a RIM-RS can report the associated Set ID to the OAM. The OAM may then use this information to identify the set of victim gNBs affected by remote interference from this aggressor gNB.

### Intra-Cell Cross Link Interference (CLI)

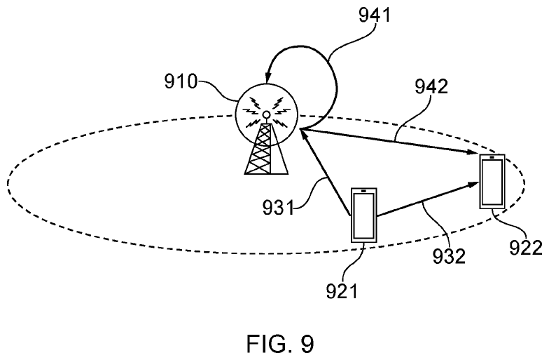

In addition to inter-cell CLI and remote interference, FD-TDD also suffers from intra-cell CLI at the gNB and at the UE. An example is shown in FIG. 9, where a gNB 910 is capable of FD-TDD and is simultaneously receiving UL transmission 931 from UE1 921 and transmitting a DL transmission 942 to UE2 922. At the gNB 910, intra-cell CLI is caused by the DL transmission 933 at the gNB's transmitter self-interfering 941 with its own receiver that is trying to decode UL signals 931. At UE2 922, intra-cell CLI 932 is caused by an aggressor UE, e.g. UE1 921, transmitting in the UL 931, whilst a victim UE, e.g. UE2 922, is receiving a DL signal 942.

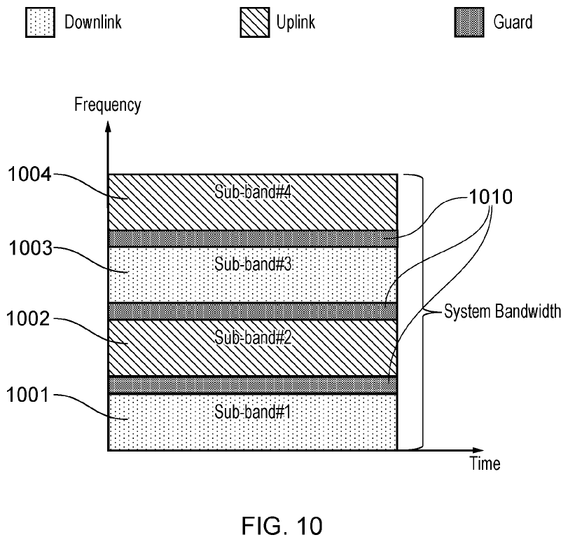

The intra-cell CLI at the gNB due to self-interference can be significant, as the DL transmission can in some cases be over 100 dB more powerful than the UL reception. Accordingly, complex RF hardware and interference cancellation are required to isolate this self-interference. In order to reduce self-interference at the gNB, one possibility is to divide the system (i.e. UE/gNB) bandwidth into non-overlapping sub-bands 1001-1004, as shown in FIG. 10, where simultaneous DL and UL transmissions occur in different sub-bands 1001-1004, i.e. in different sets of frequency Resource Blocks (RB). While FIG. 10 shows the system bandwidth as being divided into four sub-bands, substantially any number of sub-bands could be used. For example, the system bandwidth may be divided into three sub-bands, which may include two downlink sub-bands 1001, 1003 and one uplink sub-band 1002, however other sub-band arrangements are envisioned.

To reduce leakage from one sub-band 1001-1004 to another, a guard sub-band 1010 may be configured between UL and DL sub-bands 1001-1004. An example is shown in FIG. 10, where a TDD system bandwidth is divided into 4 sub-bands 1001, 1002, 1003, 1004: Sub-band #1 1001, Sub-band #2 1002, Sub-band #3 1003 and Sub-band #4 1004 such that Sub-band #1 1001 and Sub-band #3 1003 are used for DL transmissions whilst Sub-band #2 1002 and Sub-band #4 1004 are used for UL transmissions. Guard sub-bands 1010 are configured between UL Sub-band #4 1004 and DL Sub-band #3 1003, between DL Sub-band #3 1003 and UL Sub-band #2 1002 and between UL Sub-band #2 1002 and DL Sub-band #1 1001. The arrangement of sub-bands 1001-1004 shown in FIG. 10 is just one possible arrangement of the sub-bands and other arrangements are possible, and guard bands may be used in substantially any sub-band arrangement.

### Inter Sub-Band Interference

Although a transmission is typically scheduled within a specific frequency channel (or sub-band), i.e. a specific set of RBs, transmission power can leak out to other channels. This occurs because channel filters are not perfect, and as such the roll-off of the filter will cause power to leak into channels adjacent to the intended specific frequency channel. While the following discussion uses the term “channel”, the term “sub-band”, such as the sub-bands shown in FIG. 10, may be used instead.

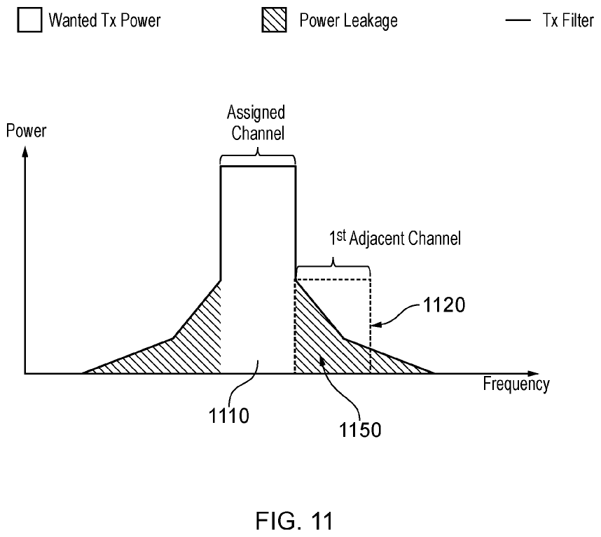

An example of transmission generating adjacent channel leakage is shown in FIG. 11. Here, the wanted transmission (Tx) power is the transmission power in the selected frequency band (i.e. the assigned channel 1110). Due to roll-off of the transmission filter and nonlinearities in components of the transmitter, some transmission power is leaked into adjacent channels (including an adjacent channel 1120), as shown in FIG. 11. The ratio of the power within the assigned frequency channel 1110 to the power in the adjacent channel 1120 is the Adjacent Channel Leakage Ratio (ACLR). The leakage power 1150 will cause interference at a receiver that is receiving the signal in the adjacent channels 1120.

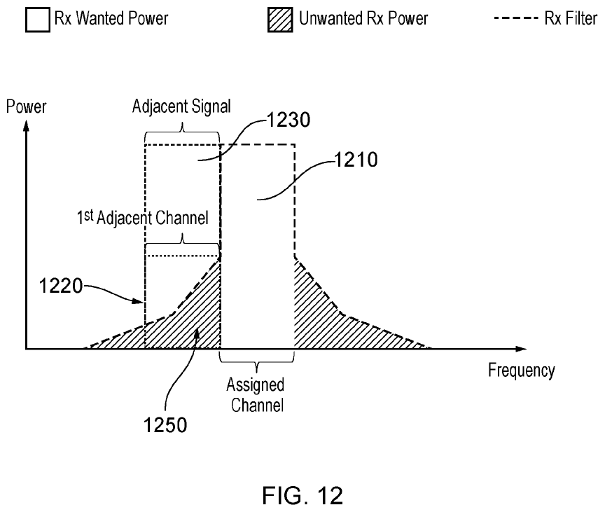

Similarly, a receiver's filter is also not perfect and will receive unwanted power from adjacent channels due to its own filter roll-off. An example of filter roll-off at a receiver is shown in FIG. 12. Here, a receiver is configured to receive transmissions in an assigned channel 1210, however the imperfect nature of the receiver filter means that some transmission power 1250 can be received in adjacent channels 1220. Therefore, if a signal 1230 is transmitted on an adjacent channel 1220, the receiver will inadvertently receive the adjacent signal 1230 in the adjacent channel 1220, to an extent. The ratio of the received power in the assigned frequency channel 1210 to the received power 1250 in the adjacent channel 1220 is the Adjacent Channel Selectivity (ACS).

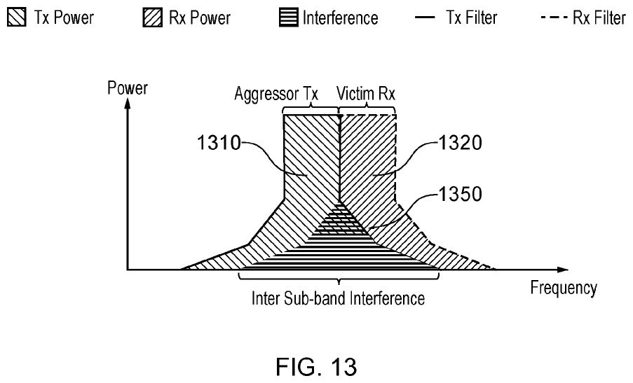

The combination of the ACL from the transmitter and the ACS of a receiver will lead to adjacent channel interference (ACI), otherwise known as inter-sub-band interference, at the receiver. An example is shown in FIG. 13, where an aggressor transmits a signal 1310 in an adjacent channel at a lower frequency than the victim's receiving 1320 channel. The interference 1350 caused by the aggressor's transmission includes the ACL of the aggressor's transmitting filter and the ACS of the victim's receiving filter. In other words, the receiver will experience interference 1350 in the ACI frequency range shown in FIG. 13.

As such, due to adjacent channel interference (ACI), cross link interference (CLI) will still occur despite the use of different sub-bands 1001-1004 for DL and UL transmissions in a FD-TDD cell. The proposed SRS-RSRP and CLI-RSSI measurements specified for inter-cell CLI assume that an aggressor and a victim transmit and receive in the same frequency channel. That is, the measurements for SRS-RSRP and CLI-RSSI at a victim UE are performed in the same frequency channel as the aggressor's frequency channel. These approaches therefore do not take into account ACI and the use of sub-bands 1001-1004 to provide information for the scheduler to mitigate against intra-cell CLI.

### Intra Sub-Band Interference

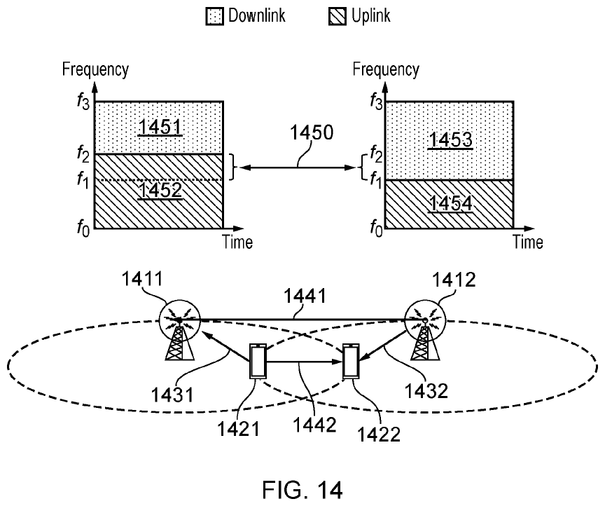

Intra sub-band interference can occur when the sub-band configurations among gNBs are not aligned in the frequency domain. Here, CLI may occur in the overlapping frequencies of inter-cell sub-bands. An example is shown in FIG. 14, where gNB1's 1411 system bandwidth is divided into UL sub-band UL-SB #1 1452 occupying f₀ to f₂ and DL sub-band DL-SB #1 1451 occupying f₂ to f₃, whilst gNB2's 1412 system bandwidth is divided into UL sub-band UL-SB #2 1454 occupying f₀ to f₁ and DL sub-band DL-SB #2 1453 occupying f₁ to f₃. The non-aligned sub-band configurations 1450 cause UL-SB #1 1452 to overlap with DL-SB #2 1453, thereby causing intra sub-band CLI within the overlapping frequencies f₁ to f₂. In this example, intra sub-band CLI 1441 occurs at gNB1 1411 due to gNB2's 1412 DL transmission 1432 within f₁ to f₂ in DL-SB #2 1453 interfering with gNB1's 1411 UL reception 1431 from UE1 1421 within f₁ to f₂ in UL-SB #1 1452. In addition, intra sub-band CLI 1442 occurs at UE2 1422 due to UE1's 1421 UL transmission 1431 within f₁ to f₂ in UL-SB #1 1452 interfering with UE2's 1422 DL reception 1432 within f₁ to f₂ in DL-SB #2 1453.

### Slot Format Indicator

Inter cell CLI and intra sub-band CLI are caused by misalignment of slot formats and sub-band configurations between gNBs in a network. One possibility to address these forms of CLI is therefore to align the slot formats and sub-band configurations for gNBs, however this reduces the gNBs' flexibility and dynamism to independently manage their own resources to adapt to changing traffic demands. That is, statically aligning these configurations would defeat the purpose of Duplex Evolution.

Instead, if a gNB is provided with information regarding a neighboring cell's slot format and sub-band configuration, the gNB's scheduler may be able to make more informed scheduling decisions in order to minimize CLI and maximize capacity. One possible way to provide such information is via the Xn interface which acts as a backhaul for gNB to gNB signaling. However, the Xn interface operates at a comparatively high layer and as such has large latencies at multiples of 20 ms. Consequently, using the Xn interface in this way is slow to respond to dynamic changes in CLI. An alternative is to use Over The Air (OTA) backhaul signaling for gNB to gNB coordination in order to manage CLI. However, present OTA backhaul proposals may be associated with large overheads.

The present disclosure introduces a slot & subband format indicator (SSFI) which provides a means of informing a gNB of another gNB's slot format and/or sub-band format in a low-latency and low overhead manner. In particular, an SSFI may indicate whether one or more OFDM symbols are allocated to DL or UL and/or contain sub-bands.

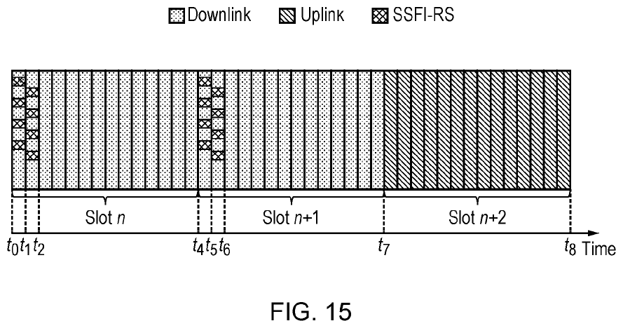

FIG. 15 shows an example of an SSFI transmission to indicate the allocation of particular slots. In this example, the SSFI is transmitted as part of a reference signal (SSFI-RS), that may be measured by a receiving gNB in order to determine a level of interference at the receiving gNB. For example, the SSFI-RS may be used in processes where gNBs monitor for reference signals to determine a level of interference. As such, a gNB may not only determine a level of interference but may also determine a slot/subband format of the gNB potentially causing interference. Accordingly, the receiving gNB may be provided with more information regarding the causes of interference by other gNBs, allowing more informed corrective measures to be taken. However the features and teachings of this example are equally applicable to examples where the SSFI is not transmitted as part of a reference signal.

In this example, the presence of an SSFI-RS transmission within a given slot indicates that a set number N_{DL} of OFDM symbols contain DL resources. However, in other examples, the presence of an SSFI-RS transmission may instead indicate that a set number N_{UL} of OFDM symbols contain UL resources. The value of N_{DL} or N_{UL} may be predetermined (i.e. fixed in the specifications or may be transmitted to a gNB through substantially any means, such as via OAM). In the example of FIG. 15, an SSFI-RS is located in the first two OFDM symbols (from time t₀ to time t₂) of Slot n, and N_{DL}=14. As such, the presence of the SSFI-RS means that all 14 OFDM symbols of Slot n are allocated to DL. Similarly, an SSFI-RS is located in the first two OFDM symbols (from time t₄ to time to) of Slot n+1. As such, as N_{DL}=14, the presence of the SSFI-RS means that all 14 OFDM symbols of Slot n+1 are also allocated to DL. No SSFI-RS are present in Slot n+2, and as such the receiving gNB determines, based on the absence of the SSFI-RS, that Slot n+2 is allocated to UL. FIG. 15 shows the SSFI-RS as being distributed across multiple continuous OFDM symbols and across multiple discrete RBs, however the SSFI-RS may take substantially any form. For example, a single SSFI-RS may be located within only a single OFDM symbol and/or across contiguous RBs.

The transmission of an SSFI may be triggered in a variety of ways. For example, a transmitting gNB (gNB1) may determine that it should transmit an SSFI. This may be triggered by performed measurements by gNB1 (such as interference measurements) and/or signaling from the network. For example, gNB1 could determine that it is operating in an interference limited environment by taking such interference measurements and hence determine that it is beneficial to transmit SSFI as there is a potential that gNB1 could interfere with another gNB). Furthermore, in some examples a gNB experiencing interference (gNB2) may transmit a request to gNB1 to transmit an SSFI for gNB2 to measure. However, other mechanisms for triggering transmission of an SSFI are possible.

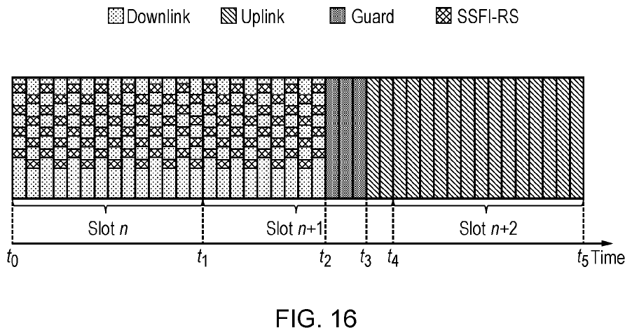

In the example of FIG. 15, N_{DL}=14, however N_{DL} may take substantially any value. For example, N_{DL} may be smaller than 14, such that the SSFI-RS indicates only that a portion of a given slot is assigned to DL. An example is shown in FIG. 16, where N_{DL}=1, such that the SSFI-RS indicates only whether a single OFDM symbol is allocated to DL resources. Conversely, N_{DL} may be greater than 14, such that an SSFI-RS indicates that more than an entire slot is assigned to DL. In the example of FIG. 16, in Slot n all OFDM symbols contain an SSFI-RS and as such the entirety of Slot n is allocated to DL resources. In Slot n+1, only the first 9 OFDM symbols contain an SSFI-RS and as such only the first 9 OFDM symbols of Slot n+1 are allocated to downlink.

In the example of FIG. 16, the 10^{th}-12^{th} OFDM symbols of Slot n+1 (from time t₂ to t₃) are allocated to guard periods. The use of guard periods is optional, however an SSFI may, for example, indicate only whether particular OFDM symbols are allocated to downlink. As such, a receiving gNB may determine that the 10^{th}-12^{th} OFDM symbols of Slot n+1 do not contain an SSFI-RS and thus that these symbols are allocated either to UL resources or to a guard period. Conversely, the SSFI may be used to indicate that a given OFDM symbol is allocated to downlink resources/a guard period, to uplink resources, or to uplink resources/a guard period. In the example of FIG. 16, as the SSFI-RS is used to indicate DL resources, the gNB determines that as no SSFI-RSs are present from t₂ to t₅ that the OFDM symbols in this time are allocated either to UL resources or to a guard period.

In some examples, the length of the SSFI-RS in the frequency domain may be used to indicate a length of a DL/UL resource in the frequency domain. In other words, the size of the frequency range over which the SSFI-RS(s) is transmitted may be used as an indication of the size of the frequency range of a DL/UL sub-band. For example, if the SSFI-RS spans N_{SSFI} PRBs, the DL sub-band occupies N_{SSFI} PRBs. In other examples, a predefined mapping of the length of the SSFI-RS in the frequency domain to the length of a sub-band may be used. Such a mapping may be predetermined and predefined in the specifications or transmitted to the gNB, e.g. via OAM. The precise frequency range of the DL and UL sub-band may be predetermined or may be signalled to the receiving gNB in any other manner.

An example mapping is shown in Table 1 below, where four possible SSFI-RS lengths (in terms of the number of RBs) are defined with each SSFI-RS length corresponding to a length of a DL sub-band, expressed as percentage of the system bandwidth. It should also be appreciated other types of mapping and unit lengths can be used.

TABLE 1
Mapping of SSFI-RS length and corresponding DL sub-band length

| | DL Sub-band Length (% of |
|---|---|
| SSFI-RS (Number of RBs) | System Bandwidth) |
| L1 | 30% |
| L2 | 60% |
| L3 | 80% |
| L4 | 100% |

In some examples, the frequency location at which an SSFI-RS is transmitted may be used as an indicator of format of a slot. For example, an SSFI-RS transmitted at a first frequency may indicate that a slot (or one or more OFDM symbols) has a first format, while an SSFI-RS transmitted at a second frequency may indicate that a slot (or one or more OFDM symbols) has a second format. The SSFI-RS frequency may be a single frequency for a single SSFI-RS, or may indicate a particular frequency of a plurality of SSFI-RSs. For example, if multiple SSFI-RSs are used, a highest, lowest or middle frequency of the SSFI-RSs may be used.

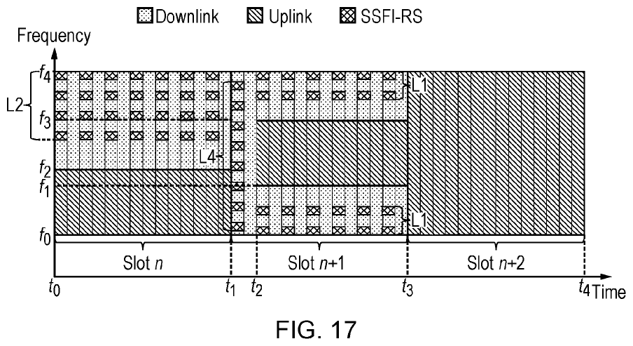

The slot formats may be predetermined and predefined in the specification or transmitted to the gNB. An example of using SSFI-RS frequency location to indicate a sub-band format is shown in FIG. 17, which also uses the length of an SSFI-RS in the manner depicted in Table 1 above. In this example, a gNB transmits multiple SSFI-RSs in a given slot. In Slot n, the SSFI-RSs transmitted have a highest frequency location of f₄ and with length L2, which indicates that the OFDM symbols in Slot n are split into sub-bands with the DL sub-band ranging from frequency f₄ to f₂ i.e. a DL sub-band occupies 60% of the system bandwidth, starting from frequency f₄. In this example, it is assumed that N_{DL}=2.

Then, in the first OFDM symbol in Slot n+1 (at time t₁) the SSFI-RSs are transmitted having a length L4, which indicates that 100% of the system bandwidth contains DL resources. At time t₂, there are two sets of SSFI-RS each with length L1. One set of SSFI-RSs is located at the top (highest frequency) of the system bandwidth, while the other set of SSFI-RSs is located at the bottom of the system bandwidth. Accordingly, this indicates that there are two DL sub-bands, each occupying 30% of the system bandwidth. As such, the length and/or location of the SSFI-RS can be used to indicate complex slot formats with minimal network overhead.

In some examples, an SSFI-RS may be used to indicate a cell ID or cell ID group with which the transmitting gNB is associated. For example, the timing or frequency of the SSFI-RS may indicate the cell ID or cell ID group. This allows other gNBs to identify which Cell ID or Cell ID Group the detected and measured SSFI-RS belongs to. Furthermore, having different locations in frequency and time would also reduce interference between SSFI-RSs from multiple different gNBs.

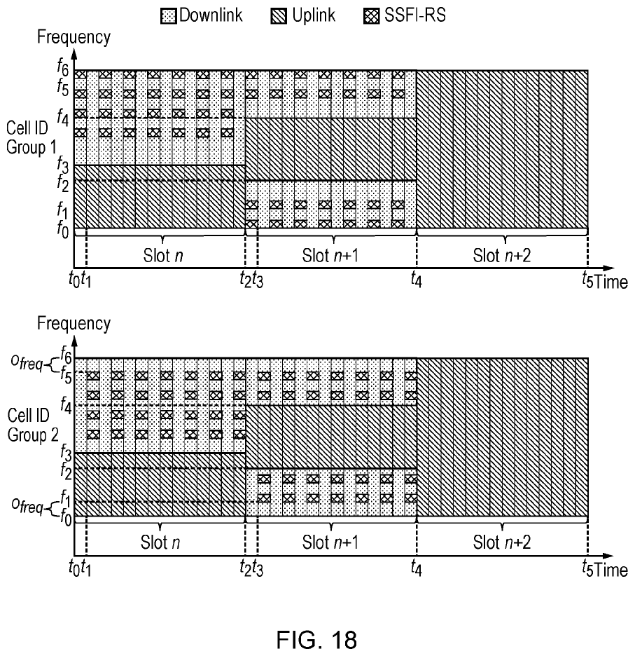

An example is shown in FIG. 18, where for gNBs with Cell ID belonging to Cell ID Group 1, the SSFI-RS is transmitted without any offset from either the top or bottom of the system bandwidth or Bandwidth Part (BWP) and the SSFI-RS occurs in odd numbered OFDM symbols (i.e. 1^{st}, 3^{rd}, 5^{th}, 7^{th}, 9^{th}, 11^{th} & 13^{th} OFDM symbol). Conversely, for gNBs with Cell ID belonging to Cell ID Group 2, the SSFI-RS is transmitted with a frequency offset O_{freq} from the top or the bottom of the system bandwidth or BWP and the SSFI-RS occurs in even numbered OFDM symbols (i.e. 2^{nd}, 4^{th}, 6^{th}, 8^{th}, 10^{th}, 12^{th} & 14^{th} OFDM symbol). A gNB monitoring for an SSFI-RS would be able to identify that the SSFI-RS shown in the top part of FIG. 18 belongs to Cell ID Group 1 since there is no frequency offset from the top or bottom of the system bandwidth for the SSFI-RS and/or because the SSFI-RS occurs in odd numbered OFDM symbols. Similarly, a gNB monitoring for an SSFI-RS would be able to identify that the SSFI-RS shown in the bottom part of FIG. 18 would be able to identify that it belongs to Cell ID Group 2 as there is an offset of O_{freq} from the top and bottom of the System Bandwidth for the SSFI-RS and/or the SSFI-RS occurs in even numbered OFDM symbols. While this example uses SSFI-RS timing & frequency locations to denote a cell ID or cell ID group, the timing & frequency locations of the SSFI-RS may be used to indicate other features, such as slot/subband format information.

In some examples, a predefined list of slot/subband formats (or OFDM symbol formats) may be determined and used in conjunction with an SSFI. The slot/subband format can then be indicated in a number of ways. For example, a predetermined slot/subband format number can be indicated using any of the above-described techniques, such as SSFI-RS frequency, the size of an SSFI-RS frequency range, and/or SSFI-RS timing. Furthermore, a predetermined slot/subband format number can be indicated directly in the SSFI-RS sequence. For example, for 8 predetermined slot/subband format configurations, different SSFI-RS sequences may indicate one of eight values in order to indicate a specific predetermined slot/subband format configurations. Additionally or alternatively different cyclic shifts of the SSFI-RS (base sequence of the SSFI-RS) may be used to indicate the predetermined slot/subband format configurations using a lookup table. The slot/subband format configurations may apply to a whole slot, multiple slots, a portion of a slot, or a non-integer number of slots. The slot/subband format configurations may be configured by OAM or may be predefined in the specifications. The slot/subband format configurations may in some cases indicate sub-bands for portions or entire slots. In other examples, the SSFI-RS sequence or cyclic shift may indicate a cell ID or cell ID group.

While the above examples relate to an SSFI or SSFI-RS being transmitted in isolation, in some cases an SSFI-RS may be associated with a physical channel e.g. carrying a message. For example, the SSFI-RS may act as a training sequence for the physical channel in the same manner as DMRS. In a further example, the SSFI-RS may indicate the physical resources of the associated physical channel or the modulation and coding scheme applied to the associated physical channel or some other parameter required for decoding the associated physical channel. That is, the SSFI-RS may indicate decoding information for the associated physical channel carrying the SSFI. In some cases, the SSFI-RS may not be part of the physical channel, such that the SSFI-RS is transmitted separately and distinctly from the physical channel, that is, the SSFI is carried by the physical channel. As such, the message carried by the physical channel may indicate the slot/subband format of the gNB, where a gNB would then decode the associated physical channel and determine the slot/subband format.

In some examples, the coding of the physical channel is matched to the detection performance of the SSFI/SSFI-RS. In other words, the decoding information for the physical channel carrying SSFI may be dependent on a detection performance of the SSFI-RS by the receiving gNB. As such, if a gNB is able to detect the SSFI-RS at a given level of performance (e.g. signal-to-noise ratio (SNR)), then the gNB is able to decode the associated physical channel carrying the SSFI. For example, the SSFI-RS may indicate that if the SSFI-RS is detected in a first SNR range the decoding information should be first decoding information, and that if the SSFI-RS is detected in a second SNR range the decoding information should be second decoding information. Accordingly, if the correct decoding information for the physical channel is the first decoding information, the gNB may only be able to decode the physical channel if the SSFI-RS is detected within the first SNR range. Accordingly, it is possible to determine an amount of resource for the SSFI-RS such that the SSFI-RS resource enables the associated physical channel to be decoded if CLI may be problematic, but the SSFI-RS is not over-dimensioned such that an associated physical channel can be decoded even though CLI is not problematic.

In some examples, a gNB may be able to decode an SSFI-RS but may be unable to decode an associated physical channel carrying the SSFI for any number of reasons. The gNB can therefore take one or more of multiple actions. For example, the gNB may assume that the gNB that transmitted the SSFI/SSFI-RS will cause interference at the receiving gNB (e.g. due to slot format misalignment) or the receiving gNB may request additional information from the transmitting gNB. As an example, the receiving gNB may request via the Xn interface a request that the slot format or sub-band information be sent via the Xn interface. In other examples, the receiving gNB can request that the transmitting gNB transmit the associated physical channel using different transmissions parameters (e.g. at a higher transmission power or using a different (e.g. more robust) modulation and/or coding scheme) to provide a more robust transmission. The physical channels discussed above may, for example, be any of a PUSCH, PUCCH, PDSCH or PDCCH. Transmission of the physical channel as a PUSCH or PUCCH would simplify reception of the physical channel by the receiving gNB, but would require extra functionality at the transmitting gNB, since a gNB transmits downlink physical channels and receives uplink physical channels in legacy systems. On the other hand, transmission of the physical channel as a PDSCH or PDCCH would simplify transmission of the physical channel by the transmitting gNB but would require extra functionality at the receiving gNB for similar reasons. In other words, a form of sidelink transmission between transmitting gNB and receiving gNB would be required in order to transmit slot format indications via a physical channel between gNBs.

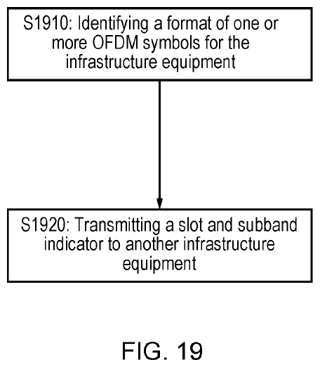

FIG. 19 illustrates a flow diagram of a method for an infrastructure equipment according to an example of the present disclosure. The method begins at step S1910 of identifying a format of one or more OFDM symbols (i.e. for at least a portion of one or more timing slots) of the infrastructure equipment. The format of the one or more OFDM symbols includes an allocation of resources by the infrastructure equipment to a particular type of traffic, the particular type of traffic being at least either downlink traffic or uplink traffic. The method proceeds to step S1920 of transmitting a slot and subband format indicator to one or more other infrastructure equipments. The one or more slot and subband format indicators indicate the format of the one or more OFDM symbols.

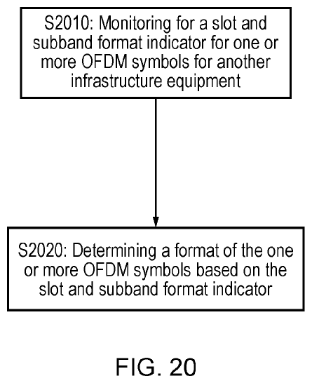

FIG. 20 illustrates a flow diagram of a method for an infrastructure equipment according to an example of the present disclosure. The method begins with step S2010 of monitoring for a slot and subband format indicator for one or more OFDM symbols for another infrastructure equipment. The method proceeds to step S2020 of determining a format of the one or more OFDM symbols based on the slot and subband format indicator. The format of one or more OFDM symbols includes an allocation of resources by the other infrastructure equipment to a particular type of traffic, the particular type of traffic being at least either downlink traffic or uplink traffic.

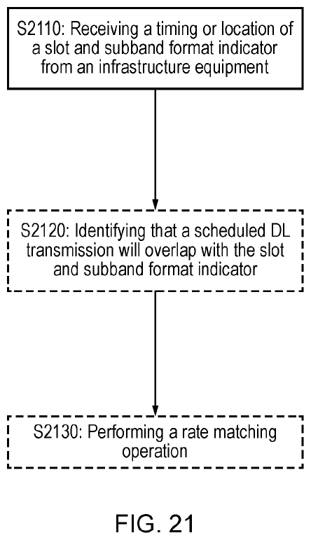

FIG. 21 illustrates a flow diagram of a method for a communications device according to an example of the present disclosure. The method beings at step S2110 of receiving a timing or location of a slot and subband format indicator from an infrastructure equipment. The slot and subband format indicator indicates a format of the one or more OFDM symbols for the infrastructure equipment, wherein the format of the one or more OFDM symbols includes an allocation of resources by the infrastructure equipment to a particular type of traffic, the particular type of traffic being at least either downlink traffic or uplink traffic. The method optionally proceeds to step S2120 of identifying that a scheduled DL transmission will overlap with the slot and subband format indicator based on the timing and/or frequency of the slot and subband format indicator. The method further optionally proceeds to step S2130 of performing a rate matching operation for the scheduled downlink transmission. The rate matching operation may comprise puncturing the reception of the resources used for the SSFI.

The above examples are described in terms of slots, where a slot contains 14 OFDM symbols, and where a slot may be a sub-division of a subframe, which may be a division of a frame. For example, a frame may be 10 ms long and may contain 10 subframes of 1 ms, where each subframe may include a variety of numbers of slots, such as 1, 2, 4, 8, or 16 slots per subframe. However, it should be appreciated that the techniques described herein are applicable to a variety of slot, subframe and frame formats. Furthermore, while various different examples of an SSFI-RS are described above, it should be appreciated that these examples may be combined with one another in any manner.

Accordingly, from one perspective there has been described a method, an infrastructure equipment, and circuitry for an infrastructure equipment to inform another infrastructure equipment of a format of one or more OFDM symbols of the infrastructure equipment. The infrastructure equipment identifies a format of the one or more OFDM symbols and provides a slot and subband format indicator to one or more other infrastructure equipments via a wireless radio interface to inform the one or more other infrastructure equipment of the format of the one or more OFDM symbols for the infrastructure equipment.

Further examples of feature combinations taught by the present disclosure are set out in the following numbered clauses:
1. A method for an infrastructure equipment, the method comprising:
identifying a format of at least a portion of one or more timing slots of the infrastructure equipment, wherein the format of the at least a portion of the one or more timing slots includes an allocation of resources by the infrastructure equipment to a particular type of traffic, the particular type of traffic being at least either downlink traffic or uplink traffic;
transmitting, to one or more other infrastructure equipments via a wireless radio interface provided by the wireless communications network, one or more slot and subband format indicators, SSFIs, within a first slot of the one or more timing slots, wherein the one or more slot format indicators indicate the format of the at least a portion of the one or more timing slots.
2. The method according to any preceding clause, wherein the one or more SSFIs are transmitted as part of a reference signal.
3. The method according to clause 2, wherein the reference signal is measurable by the other infrastructure equipment to determine a level of interference at the other infrastructure equipment.
4. The method according to any preceding clause, wherein the one or more SSFIs indicate that resources within the at least a portion of the one or more timing slots are allocated by the infrastructure equipment to the particular type of traffic.
5. The method according to any preceding clause, wherein the one or more SSFIs indicate that a predetermined time period of the one or more timing slots is allocated to the particular type of traffic.
6. The method according to clause 5, wherein the one or more SSFIs indicate that the first slot is allocated to the particular type of traffic.
7. The method according to any preceding clause, wherein the one or more SSFIs indicates that a particular frequency range of resources is allocated to the particular type of traffic.
8. The method according to clause 7, wherein the particular frequency range of resources allocated to the particular type of traffic is indicated by a transmission frequency of the one or more SSFIs.
9. The method according to any of clauses 7-8, wherein the one or SSFIs are transmitted over a frequency range, and wherein a size of the frequency range over which the one or more slot format indicators are transmitted indicates a length in the frequency domain of the resources allocated to the particular type of traffic
10. The method according to any of clauses 7-9, wherein the particular frequency range is a subset of a bandwidth of the infrastructure equipment.
11. The method according to any preceding clause, wherein the one or more SSFIs indicate a cell identifier or a group of cell identifiers with which the infrastructure equipment is associated.
12. The method according to clause 11, wherein the cell identifier or a group of cell identifiers is indicated by a frequency location at which the one or more SSFIs are transmitted, a timing of the one or more SSFIs within the one or more timing slots, and/or a size of frequency range over which the one or more SSFIs are transmitted.
13. The method according to any preceding clause, wherein the one or more SSFIs indicates that the format of the one or more timing slots is a predetermined slot format.
14. The method according to clause 13, wherein the predetermined slot & subband format is one of a plurality of predetermined slot & subband formats.
15. The method according to clause 13 or clause 14, wherein a cyclic shift of the one or more SSFIs indicates the predetermined slot format.
16. The method according to any of clauses 13-15, wherein a sequence used by of the one or more SSFIs indicates the predetermined slot format.
17. The method according to any preceding clause, wherein the one or more SSFIs are transmitted on a physical channel, where the physical channel is associated with one or more reference signals.
18. The method according to clause 17, wherein the one or more reference signals indicate decoding information for the physical channel.
19. The method according to clause 18, wherein the decoding information for the physical channel is dependent on a detection performance of the one or more reference signals by the other infrastructure equipment.
20. The method according to clause 19, further comprising:
receiving, from the other infrastructure equipment and based on the other infrastructure equipment being unable to decode the physical channel, a request for the infrastructure equipment to retransmit the physical channel with different transmission parameters.
21. The method according to any of clauses 17-20, wherein the one or more reference signals are transmitted on the physical channel carrying the SSFI.
22. The method according to any of clauses 17-21, wherein the physical channel is a physical uplink shared channel, a physical uplink control channel, a physical downlink shared channel, or a physical downlink control channel.
23. The method according to any preceding clause, further comprising:
receiving, from the other infrastructure equipment and based on the other infrastructure equipment being unable to identify the format of the at least a portion of the one or more timing slots, a request for the infrastructure equipment to transmit the format of the at least a portion of the one or more timing slots via a different interface; and
transmitting, to the other infrastructure equipment via the different interface, an indication of the format of the at least a portion of the one or more timing slots.
24. The method according to any preceding clause, further comprising:
transmitting to a communications device, an indication of a timing and/or frequency of the one or more SSFIs;
25. An infrastructure equipment comprising:
a transceiver configured to transmit signals to and/or to receive signals from a communications device via a wireless radio interface provided by the infrastructure equipment, and
a controller configured in combination with the transceiver to:
   identify a format of at least a portion of one or more timing slots of the infrastructure equipment, wherein the format of the at least a portion of the one or more timing slots includes an allocation of resources by the infrastructure equipment to a particular type of traffic, the particular type of traffic being at least either downlink traffic or uplink traffic;
   transmit, to one or more other infrastructure equipments via a wireless radio interface provided by the wireless communications network, one or more slot and subband format indicators, SSFIs, within a first slot of the one or more timing slots, wherein the one or more slot format indicators indicate the format of the at least a portion of the one or more timing slots.
26. Circuitry for an infrastructure equipment, the circuitry comprising:
transceiver circuitry configured to transmit signals to and/or to receive signals from a communications device via a wireless radio interface provided by the infrastructure equipment, and
controller circuitry configured in combination with the transceiver circuitry to:
   identify a format of at least a portion of one or more timing slots of the infrastructure equipment, wherein the format of the at least a portion of the one or more timing slots includes an allocation of resources by the infrastructure equipment to a particular type of traffic, the particular type of traffic being at least either downlink traffic or uplink traffic;
   transmit, to one or more other infrastructure equipments via a wireless radio interface provided by the wireless communications network, one or more slot and subband format indicators, SSFIs, within a first slot of the one or more timing slots, wherein the one or more slot format indicators indicate the format of the at least a portion of the one or more timing slots.
27. A method for an infrastructure equipment, the method comprising:
monitoring, in one or more timing slots, a wireless radio interface for a transmission from another infrastructure equipment for one or more slot and subband format indicators, SSFIs;
determining, based on the monitoring for one or more SSFIs, a format of the at least a portion of the one or more timing slots for the other infrastructure equipment, wherein the format of the at least a portion of the one or more timing slots includes an allocation of resources by the other infrastructure equipment to a particular type of traffic, the particular type of traffic being at least either downlink traffic or uplink traffic.
28. The method according to clause 27, wherein determining the format of the at least a portion of the one or more timing slots for the other infrastructure equipment is based on whether a SSFI is received in the one or more timing slots.
29. The method according to any of clauses 28-29, further comprising:
receiving no SSFIs from the other infrastructure equipment in the one or more timing slots.
30. The method according to any of clauses 27-29, further comprising:
receiving, from the other infrastructure equipment via the wireless radio interface, one or more SSFIs within a first slot of one or more timing slots.
31. The method according to clause 30, wherein determining the format of the at least a portion of the one or more timing slots for the infrastructure equipment is based on a size of a frequency range over which the one or more SSFIs are transmitted by the other infrastructure equipment.
32. The method according to clause 30 or clause 31, wherein determining the format of the at least a portion of the one or more timing slots for the infrastructure equipment is based on a transmission frequency of the one or more SSFIs.
33. The method according to any of clauses 30-32, wherein determining the format of the at least a portion of the one or more timing slots for the infrastructure equipment is based on a timing of the one or more SSFIs within the one or more timing slots.
34. The method according to any of clauses 30-33, wherein determining the format of the at least a portion of the one or more timing slots for the infrastructure equipment is based on a cyclic shift of the one or more SSFIs.
35. The method according to any of clauses 30-34, wherein determining the format of the at least a portion of the one or more timing slots for the infrastructure equipment is based on a sequence used by the one or more slot format indicators.
36. The method according to any of clauses 30-35, wherein the infrastructure equipment determines that the format of the one or more timing slots for the other infrastructure equipment is a predetermined slot format, wherein the predetermined slot and subband format is one of a plurality of predetermined slot formats.
37. The method according to any of clauses 30-36, further comprising:
determining, based on the one or more SSFIs, a cell identifier or a group of cell identifiers with which the other infrastructure equipment is associated.
38. The method according to clause 37, wherein the cell identifier or a group of cell identifiers is determined based on a frequency at which the one or more SSFIs are transmitted, a timing of the one or more SSFIs within the one or more timing slots, and/or a size of frequency range over which the one or more SSFIs are transmitted.
39. The method according to any of clauses 30-38, wherein the one or more SSFIs are transmitted on a physical channel, where the physical channel is associated with one or more reference signals.
40. The method according to clause 39, wherein the one or more reference signals indicate decoding information for the physical channel.
41. The method according to clause 40, further comprising:
determining decoding information for the physical channel; and
attempting to decode the physical channel using the decoding information.
42. The method according to clause 40 or clause 41, wherein the infrastructure equipment determines the decoding information based on a detection performance of the one or more reference signals by the infrastructure equipment.
43. The method according to clause 42, further comprising:
based on failing to decode the physical channel, transmitting, to the other infrastructure equipment, a request for the other infrastructure equipment to retransmit the physical channel with different transmission parameters.
44. The method according to any of clauses 39-43, wherein the one or more reference signals are transmitted on the physical channel carrying the SSFI.
45. The method according to any of clauses 39-44, wherein the physical channel is a physical uplink shared channel, a physical uplink control channel, a physical downlink shared channel, or a physical downlink control channel.
46. The method according to any of clauses 30-45, wherein the one or more SSFIs are received as part of a reference signal,
47. The method according to clause 46, wherein the method further comprises:
determining a level of interference at the other infrastructure equipment based on a measurement of the reference signal including the one or more SSFIs.
48. The method according to any of clauses 30-47, further comprising:
transmitting, to the other infrastructure equipment and based on the infrastructure equipment being unable to determine the format of the at least a portion of the one or more timing slots, a request for the other infrastructure equipment to transmit the format of the at least a portion of the one or more timing slots via a different interface; and
receiving, from the other infrastructure equipment via the different interface, an indication of the format of the at least a portion of the one or more timing slots.
49. The method according to any of clauses 17-48, further comprising:
adjusting an uplink or downlink schedule for the infrastructure equipment based on the format of the at least a portion of the one or more timing slots for the other infrastructure equipment.
50. An infrastructure equipment comprising:
a transceiver configured to transmit signals to and/or to receive signals from a communications device via a wireless radio interface provided by the infrastructure equipment, and
a controller configured in combination with the transceiver to:
   monitor, in one or more timing slots, a wireless radio interface for a transmission from another infrastructure equipment for one or more slot and subband format indicators, SSFIs;
   determine, based on the monitoring for one or more SSFIs, a format of the at least a portion of the one or more timing slots for the other infrastructure equipment, wherein the format of the at least a portion of the one or more timing slots includes an allocation of resources by the other infrastructure equipment to a particular type of traffic, the particular type of traffic being at least either downlink traffic or uplink traffic.
51. Circuitry for an infrastructure equipment, the circuitry comprising:
transceiver circuitry configured to transmit signals to and/or to receive signals from a communications device via a wireless radio interface provided by the infrastructure equipment, and
controller circuitry configured in combination with the transceiver circuitry to:
   monitor, in one or more timing slots, a wireless radio interface for a transmission from another infrastructure equipment for one or more slot and subband format indicators, SSFIs;
   determine, based on the monitoring for one or more SSFIs, a format of the at least a portion of the one or more timing slots for the other infrastructure equipment, wherein the format of the at least a portion of the one or more timing slots includes an allocation of resources by the other infrastructure equipment to a particular type of traffic, the particular type of traffic being at least either downlink traffic or uplink traffic.
52. A method for a communications device, the method comprising:
receiving, from an infrastructure equipment, an indication of a timing and/or frequency of one or more slot and subband format indicators, SSFIs,, wherein the one or more SSFIs indicate a format of the at least a portion of one or more timing slots for the infrastructure equipment, wherein the format of the at least a portion of the one or more timing slots includes an allocation of resources by the infrastructure equipment to a particular type of traffic, the particular type of traffic being at least either downlink traffic or uplink traffic.
53. The method according to clause 52, further comprising:
based on the timing and/or frequency of the one or more SSFIs, identifying that a scheduled downlink transmission to the communications device will overlap with the one or more SSFIs; and
performing a rate matching operation for the scheduled downlink transmission.
54. A communications device comprising:
a transceiver configured to transmit signals to and/or to receive signals from an infrastructure equipment of a wireless communications network via a wireless radio interface provided by the wireless communications network, and
a controller configured in combination with the transceiver to:
   receive, from an infrastructure equipment, an indication of a timing and/or frequency of one or more slot and subband format indicators, SSFIs, wherein the one or more SSFIs indicate a format of the at least a portion of one or more timing slots for the infrastructure equipment, wherein the format of the at least a portion of the one or more timing slots includes an allocation of resources by the infrastructure equipment to a particular type of traffic, the particular type of traffic being at least either downlink traffic or uplink traffic.
55. Circuitry for a communications device, the circuitry comprising comprising:
transceiver circuitry configured to transmit signals to and/or to receive signals from an infrastructure equipment of a wireless communications network via a wireless radio interface provided by the wireless communications network, and
controller circuitry configured in combination with the transceiver circuitry to:
   receive, from an infrastructure equipment, an indication of a timing and/or frequency of one or more slot and subband format indicators, SSFIs,, wherein the one or more SSFIs indicate a format of the at least a portion of one or more timing slots for the infrastructure equipment, wherein the format of the at least a portion of the one or more timing slots includes an allocation of resources by the infrastructure equipment to a particular type of traffic, the particular type of traffic being at least either downlink traffic or uplink traffic.

### REFERENCES

[1] Holma H. and Toskala A, “LTE for UMTS OFDMA and SC-FDMA based radio access”, John Wiley and Sons, 2009.
[2] RP-213591, “New SI: Study on evolution of NR duplex operation,” CMCC, RAN #94e
[3] TR38.866, “Study on remote interference management for NR (Release 16),” v16.1.0

1. A method for an infrastructure equipment, the method comprising:
identifying a format of at least a portion of one or more timing slots of the infrastructure equipment, wherein the format of the at least a portion of the one or more timing slots includes an allocation of resources by the infrastructure equipment to a particular type of traffic, the particular type of traffic being at least either downlink traffic or uplink traffic;
transmitting, to one or more other infrastructure equipments via a wireless radio interface provided by the wireless communications network, one or more slot and subband format indicators, SSFIs, within a first slot of the one or more timing slots, wherein the one or more slot format indicators indicate the format of the at least a portion of the one or more timing slots.

2. The method according to claim 1, wherein the one or more SSFIs are transmitted as part of a reference signal.

3. The method according to claim 2, wherein the reference signal is measurable by the other infrastructure equipment to determine a level of interference at the other infrastructure equipment.

4. The method according to claim 1, wherein the one or more SSFIs indicate that resources within the at least a portion of the one or more timing slots are allocated by the infrastructure equipment to the particular type of traffic.

5. The method according to claim 1, wherein the one or more SSFIs indicate that a predetermined time period of the one or more timing slots is allocated to the particular type of traffic.

6. The method according to claim 5, wherein the one or more SSFIs indicate that the first slot is allocated to the particular type of traffic.

7. The method according to claim 1, wherein the one or more SSFIs indicates that a particular frequency range of resources is allocated to the particular type of traffic.

8. The method according to claim 7, wherein the particular frequency range of resources allocated to the particular type of traffic is indicated by a transmission frequency of the one or more SSFIs.

9. The method according to claim 7, wherein the one or SSFIs are transmitted over a frequency range, and wherein a size of the frequency range over which the one or more slot format indicators are transmitted indicates a length in the frequency domain of the resources allocated to the particular type of traffic

10. The method according to claim 7, wherein the particular frequency range is a subset of a bandwidth of the infrastructure equipment.

11. The method according to claim 1, wherein the one or more SSFIs indicate a cell identifier or a group of cell identifiers with which the infrastructure equipment is associated.

12. The method according to claim 11, wherein the cell identifier or a group of cell identifiers is indicated by a frequency location at which the one or more SSFIs are transmitted, a timing of the one or more SSFIs within the one or more timing slots, and/or a size of frequency range over which the one or more SSFIs are transmitted.

13. The method according to claim 1, wherein the one or more SSFIs indicates that the format of the one or more timing slots is a predetermined slot format.

14. The method according to claim 13, wherein the predetermined slot & subband format is one of a plurality of predetermined slot & subband formats.

15. The method according to claim 13, wherein a cyclic shift of the one or more SSFIs indicates the predetermined slot format.

16. The method according to claim 13, wherein a sequence used by of the one or more SSFIs indicates the predetermined slot format.

17. The method according to claim 1, wherein the one or more SSFIs are transmitted on a physical channel, where the physical channel is associated with one or more reference signals.

18. The method according to claim 17, wherein the one or more reference signals indicate decoding information for the physical channel.

19.-24. (canceled)

25. An infrastructure equipment comprising:
a transceiver configured to transmit signals to and/or to receive signals from a communications device via a wireless radio interface provided by the infrastructure equipment, and
a controller configured in combination with the transceiver to:
identify a format of at least a portion of one or more timing slots of the infrastructure equipment, wherein the format of the at least a portion of the one or more timing slots includes an allocation of resources by the infrastructure equipment to a particular type of traffic, the particular type of traffic being at least either downlink traffic or uplink traffic;
transmit, to one or more other infrastructure equipments via a wireless radio interface provided by the wireless communications network, one or more slot and subband format indicators, SSFIs, within a first slot of the one or more timing slots, wherein the one or more slot format indicators indicate the format of the at least a portion of the one or more timing slots.

26.-53. (canceled)

54. A communications device comprising:
a transceiver configured to transmit signals to and/or to receive signals from an infrastructure equipment of a wireless communications network via a wireless radio interface provided by the wireless communications network, and
a controller configured in combination with the transceiver to:
receive, from an infrastructure equipment, an indication of a timing and/or frequency of one or more slot and subband format indicators, SSFIs, wherein the one or more SSFIs indicate a format of the at least a portion of one or more timing slots for the infrastructure equipment, wherein the format of the at least a portion of the one or more timing slots includes an allocation of resources by the infrastructure equipment to a particular type of traffic, the particular type of traffic being at least either downlink traffic or uplink traffic.

55. (canceled)
